(19) United States
(12) Patent Application Publication
(10) Pub. No.: US 2025/0337047 A1
(43) Pub. Date: Oct. 30, 2025

(54) RISER FOR THERMAL MANAGEMENT SYSTEM OF TRACTION BATTERY PACK

(71) Applicant: Ford Global Technologies, LLC, Dearborn, MI (US)

(72) Inventors: Rajaram Subramanian, Ann Arbor, MI (US); Hari Krishna Addanki, Novi, MI (US); Suriyaprakash Ayyangar Janarthanam, Canton, MI (US); Steve Droste, Canton, MI (US); Kanchana Perumalla, Troy, MI (US)

(21) Appl. No.: 18/649,922

(22) Filed: Apr. 29, 2024

(51) Int. Cl. H01M 10/6568; B60L 50/60; H01M 10/613; H01M 10/625; H01M 50/209

(52) U.S. Cl. CPC H01M 10/6568; H01M 10/613; H01M 10/625; H01M 50/209; B60L 50/60; H01M 2220/20

(57) ABSTRACT

A thermal management system for a traction battery pack includes at least one cell stack having a plurality of battery cells, and a thermal exchange device adjacent the at least one cell stack. The thermal exchange device has at least one coolant passageway that communicates a coolant. A riser is coupled to the thermal exchange device. The riser is configured to fluidly couple the thermal exchange device to a coolant delivery system.

### TECHNICAL FIELD

This disclosure relates generally to a riser used in connection with a thermal management system of a traction battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack can power the electric machines. The traction battery pack of an electrified vehicle can include battery cells.

### SUMMARY

In some aspects, the techniques described herein relate to a thermal management system for a traction battery pack, including: at least one cell stack having a plurality of battery cells; a thermal exchange device adjacent the at least one cell stack, the thermal exchange device having at least one coolant passageway that communicates a coolant; and a riser coupled to the thermal exchange device, the riser configured to fluidly couple the thermal exchange device to a coolant delivery system.

In some aspects, the techniques described herein relate to a thermal management system, wherein the riser is removably coupled to the thermal exchange device.

In some aspects, the techniques described herein relate to a thermal management system, further including a coolant port of the thermal exchange device, the riser removably coupled to the coolant port.

In some aspects, the techniques described herein relate to a thermal management system, wherein the riser threadably engages the coolant port.

In some aspects, the techniques described herein relate to a thermal management system, wherein the coolant port has external threads and the riser has internal threads.

In some aspects, the techniques described herein relate to a thermal management system, wherein the thermal exchange device includes a first plate and a second plate, wherein the first plate and the second plate are spaced a distance from each other in some areas to provide the at least one coolant passageway.

In some aspects, the techniques described herein relate to a thermal management system, wherein the coolant port is welded to at least the first plate of the thermal exchange device.

In some aspects, the techniques described herein relate to a thermal management system, wherein the first plate and the second plate are metal or metal alloy.

In some aspects, the techniques described herein relate to a thermal management system, wherein the riser extends vertically upward from the thermal exchange device.

In some aspects, the techniques described herein relate to a thermal management system, wherein the coolant delivery system is fluidly coupled to the riser with a quick-connect.

In some aspects, the techniques described herein relate to a thermal management system, wherein the coolant delivery system includes a T-connector engageable with the riser.

In some aspects, the techniques described herein relate to a thermal management system, wherein a first hose and a second hose are connected to the T-connector.

In some aspects, the techniques described herein relate to a battery pack thermal management method, including: connecting a riser to a thermal exchange device; and delivering a coolant to the thermal exchange device through the riser.

In some aspects, the techniques described herein relate to a battery pack thermal management method, wherein a cell stack is disposed on the thermal exchange device.

In some aspects, the techniques described herein relate to a battery pack thermal management method, further including connecting a coolant delivery system to the riser.

In some aspects, the techniques described herein relate to a battery pack thermal management method, further including connecting the coolant delivery system to the riser through a quick-connect.

In some aspects, the techniques described herein relate to a battery pack thermal management method, further including connecting a T-connector of the coolant delivery system to the riser.

In some aspects, the techniques described herein relate to a battery pack thermal management method, further including threadably connecting the riser to the thermal exchange device.

In some aspects, the techniques described herein relate to a battery pack thermal management method, wherein the riser threadably engages a coolant port of the thermal exchange device when coupled to the thermal exchange device.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates a perspective, expanded view of a battery pack from the electrified vehicle of FIG. 1.

FIG. 3 shows a close-up view of an area in FIG. 2.

FIG. 4 shows a perspective view of a riser from the battery pack of FIG. 2.

### DETAILED DESCRIPTION

This disclosure details a traction battery pack having a thermal management system that communicates liquid coolant to thermal exchange devices through risers that are removably coupled to the thermal exchange devices. Shipping uncoupled thermal exchange devices and risers to an assembly plant can facilitate increased package density during shipping.

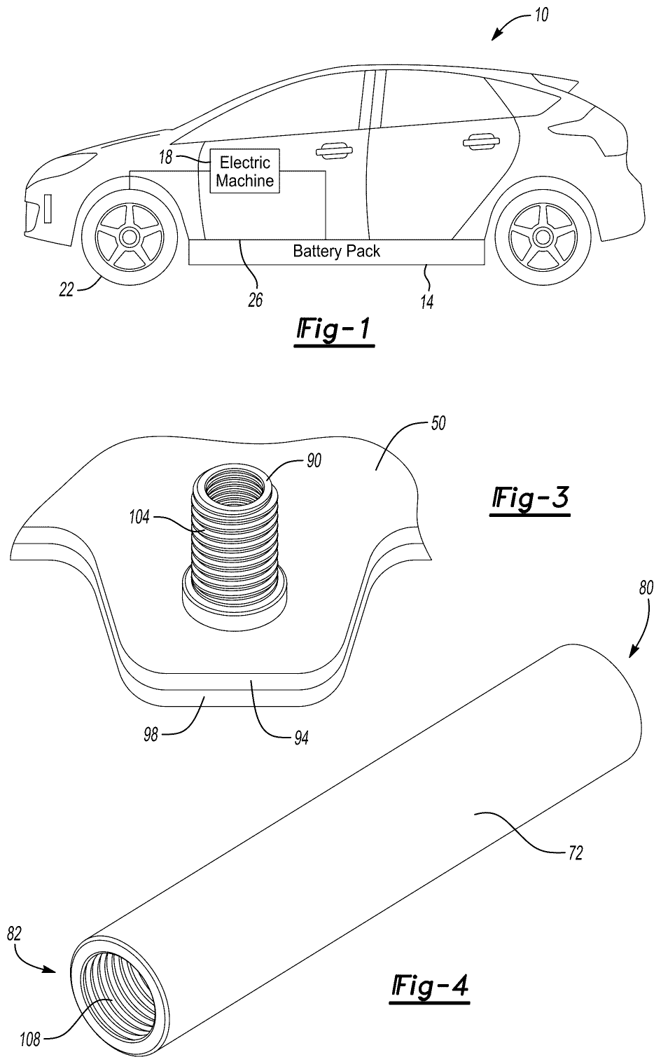

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

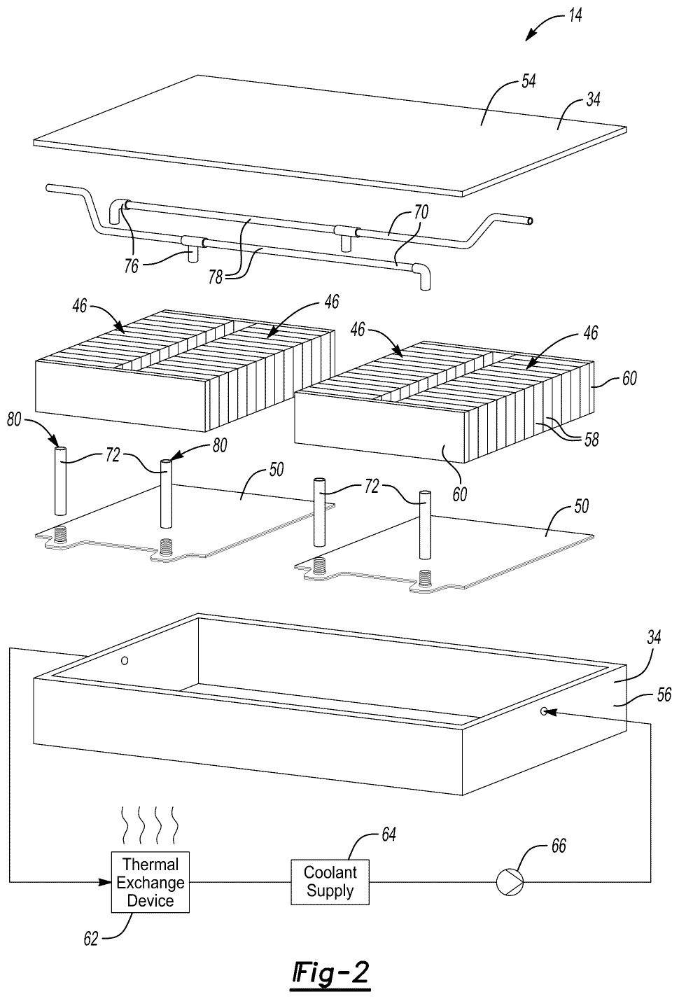

With reference now to FIG. 2, the traction battery pack 14 includes an enclosure assembly 34 housing a plurality of cell stacks 46 and at least one thermal exchange device 50.

In the exemplary embodiment, the enclosure assembly 34 includes an enclosure cover 54 and an enclosure tray 56. When the enclosure assembly 34 is assembled, the enclosure cover 54 is secured to the enclosure tray 56.

In this example, four of the cell stacks 46 are housed within the enclosure assembly 34. Other numbers of cell stacks 46 could be housed within the enclosure assembly 34 in other examples. That is, the enclosure assembly 34 could house more than four cell stacks 46 or fewer than four cells stacks 46.

The cell stacks 46 can each include a plurality of individual battery cells 58 disposed along a respective cell stack axis and positioned between endplates 60. In this example, two of the cell stacks 46 are sandwiched between respective pairs of endplates 60.

In this example, the enclosure assembly 34 houses two of the thermal exchange devices 50. Two cell stacks 46 are positioned atop each thermal exchange device 50. Other numbers of thermal exchanges devices 50 could be used in other examples. The thermal exchange devices 50 are cold plates in this example. In other examples, the thermal exchange devices 50 could be used to heat the cell stacks 46 under some conditions.

In the exemplary embodiment, a coolant is circulated through the thermal exchange devices 50 to manage thermal energy levels within the cell stacks 46 and in other areas of the traction battery pack 14. The coolant is a liquid coolant in this example.

Outside the traction battery pack 14, a heat exchanger 62, a coolant supply 64, and a pump 66 are utilized to circulate coolant to the thermal exchange devices 50 within the enclosure assembly 34. When circulated through the thermal exchange devices 50, the coolant can take on thermal energy to cool the cell stacks 46.

Within the enclosure assembly 34, a coolant delivery system 70 and a plurality of risers 72 are used to communicate coolant to and from the thermal exchange devices 50. The coolant delivery system 70, the risers 72, and the thermal exchange devices 50 provide a thermal management system for the traction battery pack 14. The risers 72 can be considered spigots in some examples.

The coolant delivery system 70 includes a plurality of connectors 76 and hose sections 78. The connectors 76 each couple to the hose sections 78 and to the one of the risers 72, which extend vertically upward from the thermal exchange devices 50. The connectors 76 engage a first, vertically upper end portion 80 of the risers 72. Some of the connectors 76 are T-connectors that are coupled to two hose sections 78 as well as the vertically upper end portion 80 of one of the risers 72. Vertical, for purposes of this disclosure is with reference to ground and an orientation of the traction battery pack 14 when installed within the vehicle 10.

With reference now to FIGS. 3 and 4 and continuing reference to FIG. 2, opposite second end portions 82 of the risers 72 are removably coupled to the thermal exchange devices 50. In this example, the second end portions 82 of the risers 72 are removably coupled to coolant ports 90 of the thermal exchange devices 50.

Prior to assembly within the traction battery pack 14, the risers 72 and thermal exchange devices 50 can be transported without the risers 72 coupled to the thermal exchange devices 50. This can reduce a packaging envelope and increase potential packaging density.

Each of the thermal exchange devices 50 includes, in addition to the coolant ports 90, a first plate 94 and a second plate 98. The first plate 94 can be secured to the second plate 98 with welds, for example. The first plate 94 and the second plate 98 can be a metal or a metal alloy.

Areas of the first plate 94 are spaced a distance from the second plate 98 to provide a coolant passageway through the respective thermal exchange device 50. The first plate 94 can be secured to the second plate 98 with welds, for example.

The coolant port 90 delivers coolant to the coolant passageway 100 within the thermal exchange device 50. The coolant port 90 can receive the coolant from the riser 72 that is removably connected to that coolant port 90. The thermal exchange devices 50 each include a second coolant port that provides an outlet for coolant from the thermal exchange device 50. The second coolant port is coupled to another of the risers 72. The coolant ports 90 are, in this example, welded to first plates 94 of the thermal exchange devices 50. Other examples can include coolant ports 90 secured in other ways.

In this example, the risers 72 threadably engage the coolant ports 90. In particular, the coolant ports 90 each include external threads 104 that threadably engage internal threads 108 of the risers 72. In other examples, the risers 72 could include external threads that engage internal threads of the coolant ports 90.

Fluid moved to the traction battery pack 14 from the pump 66 flows through hose sections 78 into one of the connectors 76. From there, at least some of the fluid exits the connector 76 into the riser 72.

The connectors 76 can engage the upper end portions 80 of the risers 72 via a push-in connection, quick-connect style connection, adhesive, or another non-threaded type of connection. Such connections between the connectors 76 and the risers 72 can facilitate assembly of the battery pack. For example, during assembly, the risers 72 can threadably engage with one of the coolant ports 90. After which, the cell stacks 46 can be positioned upon the thermal exchange device 50 placing the cell stacks 46 adjacent the thermal exchange device 50. The coolant delivery system 74 can then be installed within the traction battery pack 14 by, among other things, pressing the various connectors 76 into the respective risers 72. The risers 72 can include a bump stop to help locate the connector 76 when engaging the riser 72.

Coolant that has moved from the connector 76 into the riser 72 flows vertically downward through the riser 72 and enters the coolant passageway of the thermal exchange device 50 through the coolant port 90. Coolant can then circulate through the coolant passageway and exit the thermal exchange device 50 through the other coolant port 90.

The coolant exiting the thermal exchange device 50 flows vertically upward through the other coolant port 90 and through another riser 72. The coolant move from one of the risers 72 into another connector 76 and then to hose sections 78 that convey the coolant out of the traction battery pack 14 to the heat exchanger 62.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A thermal management system for a traction battery pack, comprising:
at least one cell stack having a plurality of battery cells;
a thermal exchange device adjacent the at least one cell stack, the thermal exchange device having at least one coolant passageway that communicates a coolant; and
a riser coupled to the thermal exchange device, the riser configured to fluidly couple the thermal exchange device to a coolant delivery system.

2. The thermal management system of claim 1, wherein the riser is removably coupled to the thermal exchange device.

3. The thermal management system of claim 2, further comprising a coolant port of the thermal exchange device, the riser removably coupled to the coolant port.

4. The thermal management system of claim 3, wherein the riser threadably engages the coolant port.

5. The thermal management system of claim 4, wherein the coolant port has external threads and the riser has internal threads.

6. The thermal management system of claim 3, wherein the thermal exchange device includes a first plate and a second plate, wherein the first plate and the second plate are spaced a distance from each other in some areas to provide the at least one coolant passageway.

7. The thermal management system of claim 6, wherein the coolant port is welded to at least the first plate of the thermal exchange device.

8. The thermal management system of claim 7, wherein the first plate and the second plate are metal or metal alloy.

9. The thermal management system of claim 1, wherein the riser extends vertically upward from the thermal exchange device.

10. The thermal management system of claim 1, wherein the coolant delivery system is fluidly coupled to the riser with a quick-connect.

11. The thermal management system of claim 1, wherein the coolant delivery system includes a T-connector engageable with the riser.

12. The thermal management system of claim 11, wherein a first hose and a second hose are connected to the T-connector.

13. A battery pack thermal management method, comprising:
connecting a riser to a thermal exchange device; and
delivering a coolant to the thermal exchange device through the riser.

14. The battery pack thermal management method of claim 13, wherein a cell stack is disposed on the thermal exchange device.

15. The battery pack thermal management method of claim 13, further comprising connecting a coolant delivery system to the riser.

16. The battery pack thermal management method of claim 15, further comprising connecting the coolant delivery system to the riser through a quick-connect.

17. The battery pack thermal management method of claim 15, further comprising connecting a T-connector of the coolant delivery system to the riser.

18. The battery pack thermal management method of claim 13, further comprising threadably connecting the riser to the thermal exchange device.

19. The battery pack thermal management method of claim 17, wherein the riser threadably engages a coolant port of the thermal exchange device when coupled to the thermal exchange device.
